(19) United States
(12) Patent Application Publication
(10) Pub. No.: US 2025/0103519 A1
(43) Pub. Date: Mar. 27, 2025

(54) REGULATING COMMAND SUBMISSION TO A SHARED PERIPHERAL DEVICE

(71) Applicant: Intel Corporation, Santa Clara, CA (US)

(72) Inventors: JUNYUAN WANG, Shanghai (CN); JOHN J BROWNE, Limerick (GB); MAKSIM LUKOSHKOV, Clarecastle (IE); XIN ZENG, Shanghai (CN); TOMASZ KANTECKI, Ennis, Co.Clare (IE); WEIGANG LI, Shanghai (CN); WENQIAN YU, Shanghai (CN)

(73) Assignee: Intel Corporation, Santa Clara, CA (US)

(21) Appl. No.: 17/790,635

(22) PCT Filed: Jun. 14, 2022
(86) PCT No.: PCT/CN2022/098745

§ 371 Date: Jul. 1, 2022

(51) Int. Cl. G06F 13/16; G06F 13/42

(52) U.S. Cl. CPC G06F 13/16; G06F 13/4282; G06F 2213/0026

(57) ABSTRACT

Apparatuses, methods, and computer readable media for regulating command submission to a shared device. A processor may receive a command for an operation to be performed by another device. The processor may determine an identifier of an address space of a process associated with the command. The processor may determine whether to accept or reject the command.

### BACKGROUND

Some computing systems allow multiple applications to share a peripheral device. Conventionally, a device driver of the peripheral device manages the order in which the peripheral device would process work submitted by each application. However, doing so leads to the undesirable result that a given application may consume a greater amount of the peripheral device's resources than other applications.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1A. illustrates a block diagram of a processor in accordance with one embodiment.

FIG. 1B illustrates a block diagram of a processor in accordance with one embodiment.

FIG. 1C illustrates a block diagram of a processor in accordance with one embodiment.

FIG. 2 illustrates an example configuration in accordance with one embodiment.

FIG. 3 illustrates an example set of metrics in accordance with one embodiment.

FIG. 4 illustrates a logic flow 400 in accordance with one embodiment.

FIG. 5 illustrates a logic flow 500 in accordance with one embodiment.

FIG. 6 illustrates a logic flow 600 in accordance with one embodiment.

FIG. 7 illustrates an aspect of a storage medium in accordance with one embodiment.

FIG. 8 illustrates a block diagram of a system including a processor in accordance with one embodiment.

### DETAILED DESCRIPTION

Embodiments disclosed herein provide processors that implement quality of service (QoS) for instructions that may be used to abstractly submit work to shared peripheral input/output (I/O) devices, such as Peripheral Component Interconnect (PCI) express (PCIe) devices, Compute Express Link®(CXL) devices, or a Universal Chiplet Interconnect Express (UCIe) device. Generally, one or more QoS policies may be defined based on different types of metrics, such as a bandwidth metric, operations per second (OPS) metric, or a percent utilization metric. A given process may be associated with one or more classes of service. The processor may monitor and/or receive performance metrics reflecting the actual use of the peripheral device by each process. When a process generates an abstract instruction to be submitted to the peripheral device, circuitry of the processor may determine whether to accept (e.g., execute or not execute) the abstract instruction based on the performance metrics and the class of service for the process.

For example, a QoS policy may specify that a process has a 10 megabits per second (Mbps) quota available for using a hardware accelerator device. If the process has submitted an abstract instruction that will use 2 Mbps, the processor may execute the instruction to submit the instruction to the shared work queue of the network device, as the 2 Mbps to be used would not exceed the 10 Mbps allocation. If, however, the abstract instruction would use 20 Mbps, processing the 20 Mbps instruction would cause the process to exceed the allocation. Therefore the processor may not execute the abstract instruction and return an indication of the same to the process.

In some embodiments, the processor may execute an instruction if the available quota is positive. For example, if the process has a 10 Mbps quota available and the instruction would use 20 Mbps, the processor may execute the abstract instruction even though doing so would cause the process to exceed the available quota. However, the resultant negative quota may carry over to a following instruction submitted by the process. As another example, if the process has a remaining allocation of zero Mbps, the process has no remaining quota, and the processor may not execute the abstract instruction and return an indication of the same to the process.

Generally, if the abstract instruction is not executed, the process may then wait a predetermined amount of time (or cycles) and resubmit the abstract instruction. The processor may then process the resubmitted abstract instruction based on then-current allocation and metrics for the process.

Advantageously, embodiments disclosed herein provide processor-based QoS for abstract instructions to be submitted to shared peripheral devices. By providing the QoS functionality in the processor and applying the QoS at a per-process granularity, more accurate and robust QoS may be applied to the use of shared peripheral devices. Similarly, by providing the QoS functionality in the processor, different peripheral device manufacturers do not need to provide a similar solution in their devices. Instead, these devices can rely on the QoS services provided by the processor. Furthermore, by providing the QoS functionality in the processor, system resources may be conserved relative to conventional approaches where the processor transmits the instruction to the peripheral device for QoS handling. For example, if the processor does not execute an instruction, system resources are conserved by not transmitting the instruction via an interconnect to the shared peripheral device for rejection or further delay.

With general reference to notations and nomenclature used herein, one or more portions of the detailed description which follows may be presented in terms of program procedures executed on a computer or network of computers. These procedural descriptions and representations are used by those skilled in the art to convey the substances of their work to others skilled in the art. A procedure is here, and generally, conceived to be a self-consistent sequence of operations leading to a desired result. These operations are those requiring physical manipulations of physical quantities. Usually, though not necessarily, these quantities take the form of electrical, magnetic, or optical signals capable of being stored, transferred, combined, compared, and otherwise manipulated. It proves convenient at times, principally for reasons of common usage, to refer to these signals as bits, values, elements, symbols, characters, terms, numbers, or the like. It should be noted, however, that all of these and similar terms are to be associated with the appropriate physical quantities and are merely convenient labels applied to those quantities.

Further, these manipulations are often referred to in terms, such as adding or comparing, which are commonly associated with mental operations performed by a human operator. However, no such capability of a human operator is necessary, or desirable in most cases, in any of the operations described herein that form part of one or more embodiments. Rather, these operations are machine operations. Useful machines for performing operations of various embodiments include digital computers as selectively activated or configured by a computer program stored within that is written in accordance with the teachings herein, and/or include apparatus specially constructed for the required purpose or a digital computer. Various embodiments also relate to apparatus or systems for performing these operations. These apparatuses may be specially constructed for the required purpose. The required structure for a variety of these machines will be apparent from the description given.

Reference is now made to the drawings, wherein like reference numerals are used to refer to like elements throughout. In the following description, for the purpose of explanation, numerous specific details are set forth in order to provide a thorough understanding thereof. It may be evident, however, that the novel embodiments can be practiced without these specific details. In other instances, well-known structures and devices are shown in block diagram form in order to facilitate a description thereof. The intention is to cover all modification, equivalents, and alternatives within the scope of the claims.

In the Figures and the accompanying description, the designations “a” and “b” and “c” (and similar designators) are intended to be variables representing any positive integer. Thus, for example, if an implementation sets a value for a=5, then a complete set of components 123 illustrated as components 123-1 through 123-a (or 123a) may include components 123-1, 123-2, 123-3, 123-4, and 123-5. The embodiments are not limited in this context.

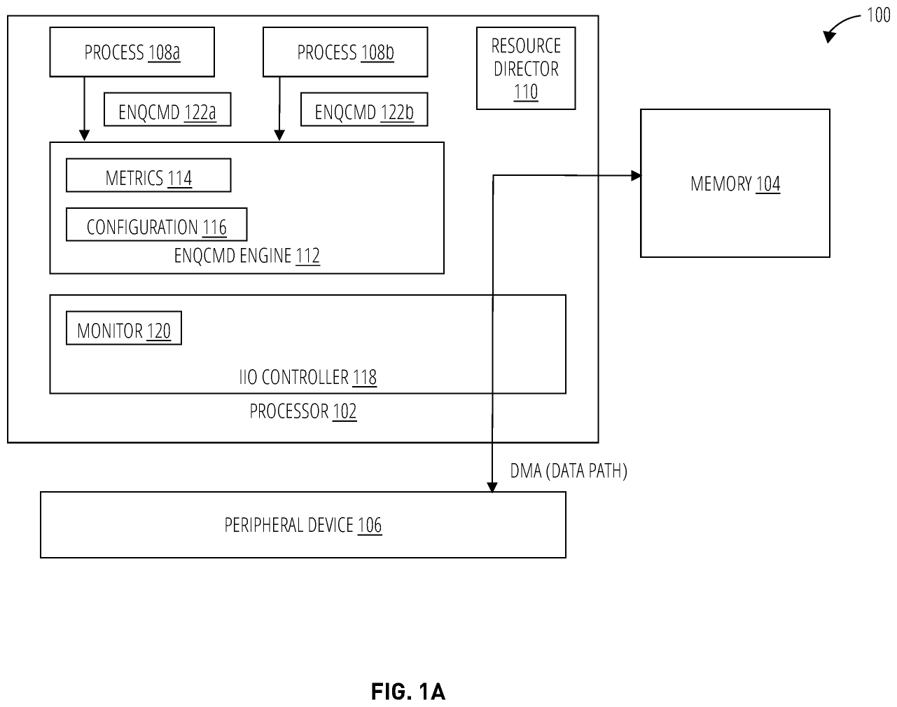

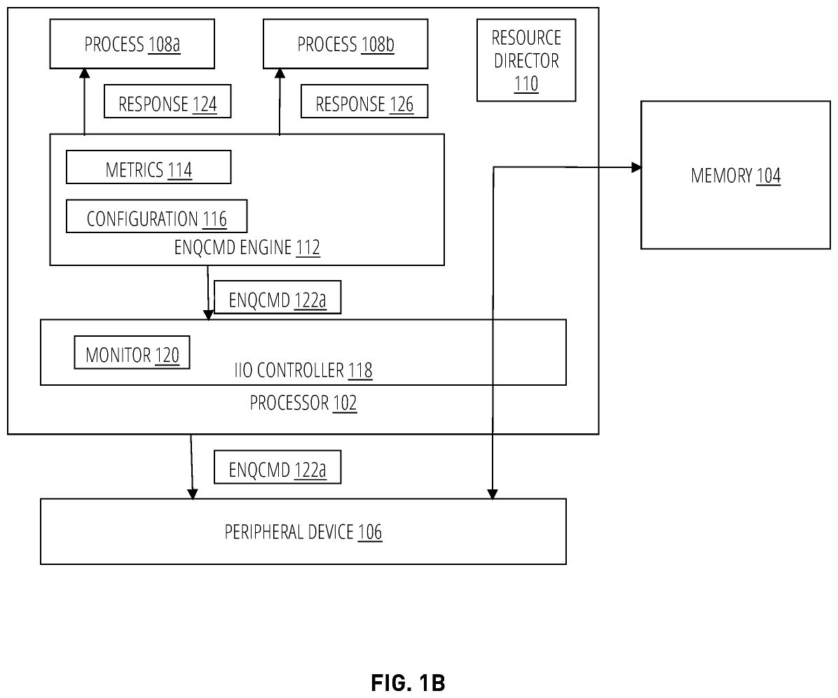

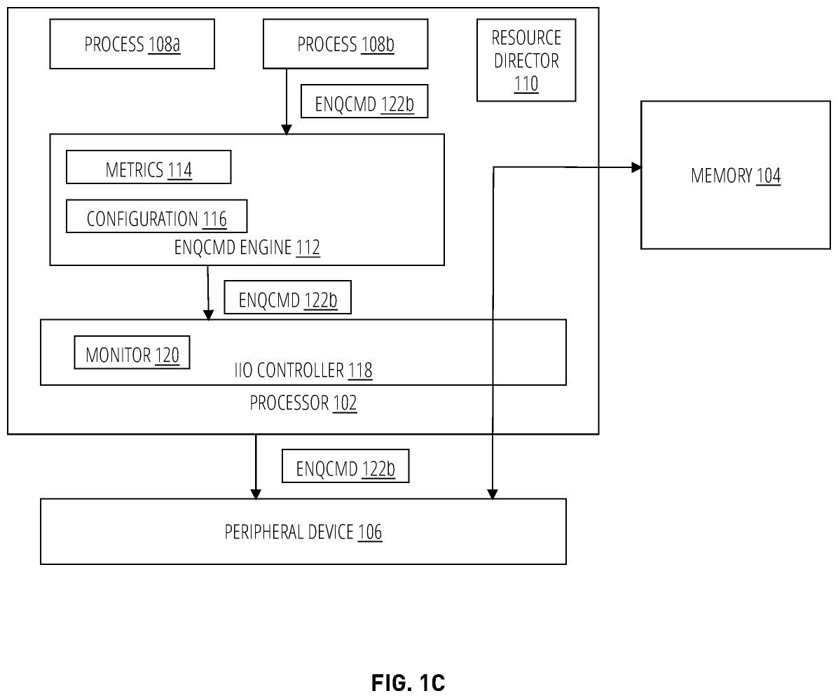

FIG. 1A is a block diagram illustrating a system 100 that regulates command submission to a shared device, according to one embodiment. As shown, the system 100 includes one or more processors 102, a memory 104, and one or more peripheral devices 106. The peripheral device 106 may be referred to as “another device” herein. The processor 102 is representative of any type of processor circuit. Processor 102 may be any processor or processing device, such as a microprocessor, an embedded processor, a digital signal processor (DSP), a network processor, a handheld processor, an application processor, a co-processor, a system on a chip (SOC), or other device to execute code. Processor 102, in one embodiment, includes two or more processor cores (not pictured), which may include asymmetric cores or symmetric cores. However, processor 102 may include any number of processing elements that may be symmetric or asymmetric.

Memory 104 can be any type of memory circuit or memory device, such as a dynamic random access memory (DRAM) device, a static random access memory (SRAM) device, flash memory device, phase-change memory device, and the like.

Peripheral device 106 is representative of any type of peripheral device that may connect to the processor 102 and/or the memory 104 via an interconnect fabric. Examples of an interconnect fabric include the PCIe architecture, the CXL architecture, and the UCIe architecture. Therefore, the peripheral device 106 may be another device that is communicably coupled to the processor 102 via an interconnect. As shown, the peripheral device 106 may connect to the processor 102 and/or the memory 104 via an integrated input/output (IIO) controller 118. The IIO controller 118 is representative of any type of controller that provides connections to I/O devices via a local I/O bus. In one embodiment, IIO controller 118 is a root hub, root complex, or root controller in a PCIe interconnect hierarchy. The IIO controller 118 may similarly be a component (e.g., a controller) of a CXL architecture or the UCIe architecture. The use of a particular type of IIO controller 118 as a reference example herein should not be considered limiting of the disclosure.

Examples of peripheral devices 106 include, without limitation, graphics processing units (GPUs), accelerator devices, network interface devices, storage devices, and the like. The peripheral device 106 may utilize direct memory access (DMA) to access the memory 104 in a manner that bypasses the processor 102. Furthermore, the peripheral device 106 may implement a shared work queue (not pictured) that allows different entities to share the peripheral device 106. For example, the peripheral device 106 may be shared according to the Single Root I/O virtualization (SR-IOV) architecture and/or the Scalable I/O virtualization (S-IOV) architecture. Embodiments are not limited in these contexts.

For example, as shown, two processes 108a, 108b may execute on the processor 102. The processes 108a, 108b may execute on the same core of processor 102 or on different cores of the processor 102. Processes 108a and 108b are representative of any executable code. For example and without limitation, processes 108a, 108b may be applications, threads, containers, microservices, and/or virtual machines (VMs). Often, process 108a and process 108b may have workloads or other operations that are to be processed at least in part by the peripheral device 106. Each process 108a, 108b, may be allocated a portion of the peripheral device 106. For example, the processes 108a, 108b may each be assigned a virtualized instance of the peripheral device 106. Examples of virtualized instances of the peripheral device 106 include assignable interfaces (AIs) in a S-IOV architecture or virtual functions (VFs) in an SR-IOV architecture.

In some embodiments, process 108a and process 108b may generate instructions that, when executed by the processor 102, atomically submit a work descriptor to the peripheral device 106. One example of an instruction that atomically submits a work descriptor to the peripheral device 106 is the ENQCMD command (which may be referred to as “ENQCMD” herein) supported by the Intel® Instruction Set Architecture (ISA). However, any instruction having a descriptor that includes indications of the operation to be performed, a source virtual address for the descriptor, a destination virtual address for a device-specific register of the peripheral device 106, virtual addresses of parameters, a virtual address of a completion record, and an identifier of an address space of the submitting process is representative of an instruction that atomically submits a work descriptor to the peripheral device 106. In one embodiment, the identifier of the address space of the submitting process is a Process Address Space ID (PASID). However, other identifiers may be used, and the use of a particular identifier should not be considered limiting of the disclosure. Generally, the PASID enables sharing of the peripheral device 106 across multiple processes, such as process 108a and process 108b while providing each process a complete virtual address space. In some embodiments, a guest operating system (OS) in a virtualized environment may issue an ENQCMD. In such embodiments, a hypervisor may handle the ENQCMD issued by the guest OS. For example, to handle the ENQCMD, the hypervisor may leverage an emulator that emulates the processor 102, where the emulator is extended to handle the ENQCMD. One example of a virtualized environment is the Kernel-based Virtual Machine (KVM) and one example of an emulator is QEMU. In such embodiments, the emulator and/or hypervisor may be configured to perform some or all of the operations performed by the processor 102 described herein to process ENQCMDs.

Therefore, as shown, the process 108a may generate ENQCMD 122a, while process 108b may generate ENQCMD 122b. The ENQCMD 122a and ENQCMD 122b may be generated at the same and/or different times. Conventionally, the processor 102 would execute these instructions which causes the instructions to be submitted to the peripheral device 106 for processing. In some such scenarios, the peripheral device 106 (and/or a device driver thereof) would perform QoS processing, arbitration, etc., to allow each command to be processed by the peripheral device 106. However, doing so may unnecessarily consume system resources and may lead to one process consuming a greater amount of resources of the peripheral device 106 device than other processes.

Advantageously, the processor 102 includes the ENQCMD engine 112, which is circuitry configured to apply QoS to ENQCMD commands targeting the peripheral device 106. In some embodiments, the ENQCMD engine 112 may be implemented as one or more IP cores of the processor 102. As shown, the ENQCMD engine 112 includes a metrics 114 and a configuration 116. The metrics 114 are representative of performance metrics reflecting the use of the peripheral device 106 (and/or other system resources) to process ENQCMD commands on behalf of a process. For example, the metrics 114 may include bandwidth (e.g., megabits per second, gigabits per second, etc.) consumed in executing operations associated with one or more ENQCMD commands, operations per second (OPS) executed in executing operations associated with one or more ENQCMD commands, and/or a percent utilization of the peripheral device 106 in executing operations associated with one or more ENQCMD commands. The metrics 114 may be collected on a per-process granularity by collecting the metrics at the PASID level (e.g., the address space level). In some embodiments, the ENQCMD engine 112 may monitor the OPS used by a given process at the PASID level of granularity. In some embodiments, the monitor 120 of the IIO controller 118 may monitor the bandwidth used by a given process at the PASID level of granularity. The IIO controller 118 may provide the measurements to the ENQCMD engine 112 for storage in the metrics 114. In some embodiments, the processor 102 may determine the percent utilization of the peripheral device 106 by a given process and store the percent utilization levels in the metrics 114. In some embodiments, the metrics 114 reflect use for a current QoS interval, which may be a time interval (e.g., 1 microsecond, 1 millisecond, 1 second, etc.). In some such embodiments, the metrics 114 may be reset at each of a plurality of new intervals.

The configuration 116 may generally store QoS policies for different processes that generate ENQCMD commands. For example, the configuration 116 may specify quotas (or thresholds) for different processes at one or more intervals. In some embodiments, the quotas may be associated with one or more PASIDs associated with a process. The quotas may further be associated with one or more specified registers of the peripheral device 106. The quotas may include bandwidth quotas, OPS quotas, and/or percent utilization quotas (e.g., a percentage of the resources of the peripheral device 106). Furthermore, each quota value may be associated with a respective minimum quota value (e.g., a predetermined minimum bandwidth quota, a predetermined minimum OPS quota value, a predetermined percent utilization minimum quota value). The minimum quota value may be any suitable value, such as zero Mbps, zero OPS, or zero percent utilization. In some embodiments, the configuration 116 may be based on a service level agreement (SLA), e.g., for one or more customers in a cloud computing services architecture.

Furthermore, at least a portion of the configuration 116 may be defined by a user in one or more classes of service via the resource director 110. For example, the user may define quotas, minimum quota thresholds, and any other relevant parameters for one or more of a plurality of processes based on PASID. The resource director 110 is hardware and/or software configured to provide a framework for resource monitoring and allocation, such as bandwidth used in accessing the memory 104. One example of a resource director is the Intel@Resource Director Technology (Intel® RDT) Framework. In some embodiments, the ENQCMD engine 112 is a component of the resource director 110. Therefore, the resource director 110 may be extended to incorporate resource monitoring and allocation for peripheral devices 106. The resource monitoring and allocation for the peripheral devices 106 performed by the resource director 110 may include monitoring and allocation operations in addition to the operations described with respect to the ENQCMD engine 112.

Therefore, the ENQCMD engine 112 may process the ENQCMD 122a and ENQCMD 122b based on the metrics 114 and/or configuration 116 associated with process 108a and process 108b. For example, the configuration 116 may maintain a current quota for a given PASID. The quotas in the configuration 116 may be updated based on metrics 114 as each ENQCMD is executed for a given PASID. For example, the configuration 116 may specify a quota of 10 Mbps for process 108a and a quota of 0 (zero) Mbps for process 108b for a current interval. In some embodiments, the ENQCMD engine 112 may determine whether the quotas exceed a quota threshold, such as 0 Mbps, or another predetermined quota threshold. Because the quota for process 108a exceeds the quota threshold (e.g., is greater than zero), the ENQCMD engine 112 may accept (e.g., execute) the ENQCMD 122a, as the process 108a has available quota for the current interval. Similarly, because the quota for process 108b does not exceed the quota threshold (e.g., is not greater than zero), the ENQCMD engine 112 may not execute (e.g., reject) ENQCMD 122b, as process 108b has no remaining quota for the current interval.

In some embodiments, ENQCMD engine 112 may consider the amount of resources to be used by ENQCMD 122a and ENQCMD 122b. For example, the ENQCMD engine 112 may determine, based on the operands of each instruction, that the operations associated with ENQCMD 122a may use 3 Mbps of PCIe I/O bandwidth for a compression operation while the operations associated with ENQCMD 122b may use 20 Mbps for a compression operation. Therefore, executing the operations associated with ENQCMD 122a would not cause process 108a to exceed its QoS quota of 10 Mbps. However, executing the operations associated with ENQCMD 122b would cause process 108b to further exceed its 0 Mbps quota. Therefore, the determination to accept ENQCMD 122a or not accept ENQCMD 122b may be based on the amount of resources to be used by the respective commands.

As another example, if the operations associated with ENQCMD 122a would use 25 Mbps of PCIe I/O bandwidth for the compression operation, the ENQCMD engine 112 may accept the ENQCMD 122a because the quota for process 108a exceeds the minimum quota threshold (e.g., the 10 Mbps quota is greater than zero, and process 108a has remaining quota). However, subsequent to the completion of the compression operation, the quota for process 108a would be −15 Mbps for the current interval. Therefore, the ENQCMD engine 112 may reject subsequent ENQCMDs received from the process 108a until the quota for process 108a exceeds the minimum quota threshold (e.g., until process 108a has available quota). Generally, at each interval, the ENQCMD engine 112 increases the quota for a given process based on the configuration 116. Therefore, if the quota for process 108a is 10 Mbps, at each interval the process 108a would return to a positive quota of 5 Mbps after 2 seconds, and subsequent ENQCMDs submitted by the process 108a may be accepted.

The above examples apply equally to OPS and percent utilization embodiments. For example, the configuration 116 may specify that process 108a has a quota of 10 million PCIe OPS, while process 108b has a quota of 0 PCIe OPS. The ENQCMD engine 112 may then compare the quotas to associated OPS minimum thresholds (e.g., 0 OPS) in the configuration 116. Based on the comparison, the ENQCMD engine 112 may determine that the OPS quota for process 108b does not exceed the OPS minimum threshold (e.g., process 108b has exhausted its quota), while the OPS quota for process 108a exceeds the OPS minimum threshold. Therefore, the ENQCMD engine 112 may accept the ENQCMD 122a, while not accepting ENQCMD 122b. As stated, the ENQCMD engine 112 may further consider the OPS to be used in processing ENQCMD 122a and ENQCMD 122b when making the determination. For example, if ENQCMD 122a requires 9 million OPS, the ENQCMD 122a would not cause the OPS quota of process 108a to exceed its quota threshold. Therefore, ENQCMD engine 112 would accept and execute the ENQCMD 122a. However, processing ENQCMD 122b would cause the OPS quota for process 108b to further exceed its OPS quota, and ENQCMD engine 112 would further not accept ENQCMD 122b based on the OPS quota being exceeded.

As another example, if ENQCMD 122a uses 25 million OPS for the compression operation, the ENQCMD engine 112 may accept the ENQCMD 122a because the quota for process 108a exceeds the minimum quota threshold (e.g., the 10 million OPS quota is greater than zero, and process 108a therefore has remaining quota). However, subsequent to the completion of the compression operation, the quota for process 108a would be −15 million OPS. Therefore, the ENQCMD engine 112 may reject subsequent ENQCMDs received from the process 108a until the OPS quota for process 108a exceeds the minimum quota threshold. As stated, at each interval, the ENQCMD engine 112 increases the quota for a given process based on the configuration 116. Therefore, if the quota for process 108a is 10 million OPS, the process 108a would return to a positive quota of 5 million OPS per second after 2 seconds, and subsequent ENQCMDs submitted by the process 108a may be accepted.

As another example, the configuration 116 may specify that process 108a has 10% utilization quota of peripheral device 106, while process 108b has a −5% utilization quota of peripheral device 106. The ENQCMD engine 112 may then compare the quotas to the associated quota thresholds in the configuration 116. Based on the comparison, the ENQCMD engine 112 may determine that the percent utilization quota of process 108b does not exceed the percent utilization quota threshold (e.g., process 108b has exhausted its quota), while the percent utilization quota of process 108a exceeds the percent utilization quota threshold (e.g., process 108a has remaining quota available). Therefore, the ENQCMD engine 112 may permit processing of the ENQCMD 122a, while temporarily not accepting ENQCMD 122b.

As stated, the ENQCMD engine 112 may further consider the percent of the resources of the peripheral device 106 to be used in processing ENQCMD 122a and ENQCMD 122b when making the determination. For example, if ENQCMD 122a requires 9% of the resources of peripheral device 106, executing the ENQCMD 122a would not cause the utilization quota of process 108a to exceed the percentage utilization quota, and the ENQCMD engine 112 would accept the ENQCMD 122a. However, regardless of the estimated percentage used, processing ENQCMD 122b would cause process 108b to further exceed its quota, and ENQCMD engine 112 would not accept ENQCMD 122b at this time.

However, as another example, if the ENQCMD 122a requires 15% of the resources of peripheral device 106, subsequent to executing the ENQCMD 122a, the utilization quota of process 108a to would be −5%. Therefore, the ENQCMD engine 112 may reject subsequent ENQCMDs received from the process 108a until the percent utilization quota for process 108a exceeds the minimum threshold. As stated, at each interval, the ENQCMD engine 112 increases the quota for a given process based on the configuration 116. Therefore, if the percent utilization quota for process 108a is 10% of peripheral device 106, the process 108a would return to a positive quota of 5% per second after 1 second, and subsequent ENQCMDs submitted by the process 108a may be accepted.

FIG. 1B illustrates an embodiment where the ENQCMD engine 112 accepted ENQCMD 122a and did not accept ENQCMD 122b. As shown, ENQCMD 122a is executed and submitted to peripheral device 106 via IIO controller 118. The peripheral device 106 may then perform the operations associated with ENQCMD 122a. In some embodiments, the ENQCMD 122a is submitted to the peripheral device 106 using non-posted semantics. For example, when executing the ENQCMD 122a, the processor 102 may move the descriptor information included in the ENQCMD 122a with the encoded PASID of the process 108a to an abstracted register interface of the peripheral device 106 using a non-posted memory write.

Because non-posted semantics are used, the ENQCMD engine 112 and/or another component of the processor 102 returns a response 124 to the process 108a. The response 124 may generally indicate that the ENQCMD 122a was accepted by the peripheral device 106.

As the peripheral device 106 performs the processing operations associated with ENQCMD 122a (e.g., executing a workload, performing one or more processing operations, etc.), various performance metrics 114 may be collected. For example, the ENQCMD engine 112 may determine the OPS used in executing the processing operations associated with ENQCMD 122a. Generally, during execution of ENQCMD 122a, the ENQCMD engine 112 may retrieve the unique 20 bits process PASID for the process 108a from a register (e.g., the IA32_PASID MSR in the Intel ISA). In virtualized environments, the ENQCMD engine 112 may translate a guest-PASID in the register to a host-PASID. The ENQCMD engine 112 may then add the host-PASID to the PASID field of the payload of ENQCMD 122a. Doing so provides the ENQCMD engine 112 the capability to measure the ISA execution OPS for a specified PCIe device at the PASID level of granularity. The ENQCMD engine 112 may store the OPS used in the metrics 114 and/or update the configuration 116 for process 108a based on the OPS used.

Furthermore, the monitor 120 may determine the amount of bandwidth used and return the same to the ENQCMD engine 112. In some embodiments, the IIO controller 118 determines the runtime bandwidth used by a given process based on the PCIe Transaction Layer Packet (TLP) prefix field of one or more packets, where the TLP prefix field may specify the PASID of the process. By identifying the PASID in the TLP prefix field, the IIO controller 118 is able to allocate bandwidth used by one or more packets to a specific PASID. In some embodiments, the IIO controller 118 is enriched to support telemetry events to monitor the bandwidth used at the PASID level. The telemetry events may include, without limitation, downstream read operations at the PASID level (e.g., where the processor 102 reads data in the peripheral device 106 on behalf of a PASID), downstream write operations at the PASID level (e.g., where the processor 102 writes data to the peripheral device 106 on behalf of a PASID), upstream read operations (where the peripheral device 106 device reads data in the processor 102 and/or memory 104 on behalf of a PASID), and upstream write operations (e.g., where the peripheral device 106 writes data to the processor 102 and/or memory 104 on behalf of a PASID). Once the bandwidth used is determined, the monitor 120 may provide the bandwidth used to the ENQCMD engine 112, which may then update the metrics 114 to reflect the bandwidth used in executing the processing operations associated with ENQCMD 122a. Furthermore, the bandwidth quota for process 108a in the configuration 116 may be reduced based on the bandwidth used.

Similarly, the processor 102 may determine a percent utilization of the peripheral device 106 in executing the processing operations associated with ENQCMD 122a. The metrics 114 may be updated to reflect the percent utilization. The percent utilization quota for process 108a in the configuration 116 may be updated based on the determined percent utilization at the PASID level of granularity. Advantageously, therefore, the metrics 114 and/or configuration 116 for process 108a are updated at the PASID level of granularity.

Furthermore, as shown, the ENQCMD engine 112 returns a response 126 to the process 108b. The response 126 may be any type of response indicating that processing of the ENQCMD 122b was not accepted (e.g., the ENQCMD 122b was not executed). Doing so may cause the process 108b to wait (e.g., a predetermined amount of time and/or cycles) and resubmit the ENQCMD 122b at a later time.

FIG. 1C depicts an embodiment where the process 108b resubmits the ENQCMD 122b. The ENQCMD engine 112 may again perform QoS processing for the ENQCMD 122b as described above. For example, the ENQCMD engine 112 may determine whether the current quota for process 108b permits execution of the workload associated with ENQCMD 122b. The current quota may be greater than the prior quota discussed with reference to FIGS. 1A-1B, e.g., based on the quota being increased after one or more elapsed intervals. If the current quota for process 108b exceeds the minimum quota threshold (e.g., is greater than zero, and process 108b has available quota), the ENQCMD engine 112 may permit execution of the ENQCMD 122b. If the quota does not exceed the quota threshold, the ENQCMD engine 112 may again not accept the ENQCMD 122b.

As shown, FIG. 1C depicts an embodiment where the ENQCMD 122b is executed and submitted to the peripheral device 106 via the IIO controller 118 via a non-posted write as described above. The ENQCMD engine 112 may return a response to the process 108b indicating that the ENQCMD 122b was accepted by the peripheral device 106. As the peripheral device 106 processes ENQCMD 122b, the amount of bandwidth, OPS, and/or percent of the peripheral device 106 used may be determined. The ENQCMD engine 112 may then update the metrics 114 for process 108b to reflect the amount of bandwidth, OPS, and/or percent of the peripheral device 106 used in executing the workload associated with ENQCMD 122b. Furthermore, the bandwidth quota, percent utilization quota, and/or the OPS quota for process 108b in the configuration 116 may be reduced based on the bandwidth, percent utilization, and/or OPS used, respectively. As stated, the bandwidth, OPS, and/or percent utilization are measured at the PASID level of granularity. Therefore, the metrics 114 and/or configuration 116 for process 108b are updated at the PASID level of granularity.

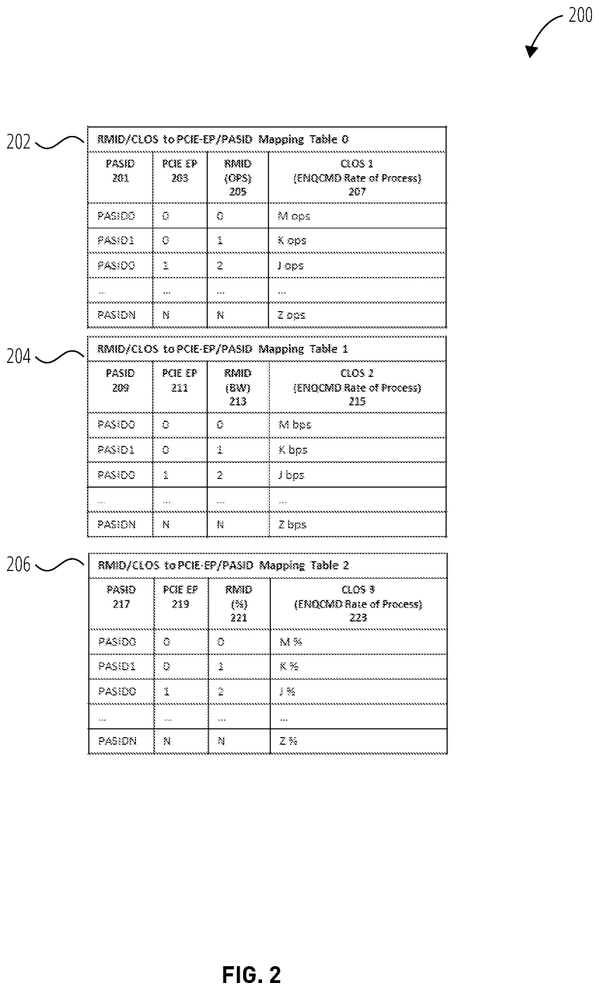

FIG. 2 is a schematic 200 illustrating example classes of service for processes that submit ENQCMDs, according to one embodiment. As shown, FIG. 2 includes mapping tables 202, 204, and 206. Generally, each mapping table 202, 204, 206 may represent one or more classes of service for QoS purposes. In some embodiments, a user may define the values in each table 202, 204, 206, e.g., via the resource director 110. The user may bind each table 202, 204, or 206 to a process, thereby associating each table with the process via the corresponding PASID of the process. As shown, table 202 is based on PCIe OPS, and includes a PASID column 201, a PCIe endpoint (EP) column 203, an RMID column 205, and an OPS quota column 207. The PASID column 201 may specify a PASID associated with a process. The PCIe endpoint column 203 may specify a PCIe endpoint, e.g., one of the peripheral devices 106. The RMID column 205 may specify a resource monitoring identifier (ID), which may be a per-thread tag for monitoring resource utilization based on OPS. The OPS quota column 207 may specify an OPS quota for the process/PASID.

As shown, table 204 is based on bits per second (bps) of PCIe I/O bandwidth, and includes a PASID column 209, a PCIe endpoint column 211, an RMID column 213, and a bandwidth quota column 215. The PASID column 209 may specify a PASID associated with a process. The PCIe endpoint column 211 may specify a PCIe endpoint, e.g., one of the peripheral devices 106. The RMID column 213 may specify a resource monitoring identifier (ID), which may be a per-thread tag for monitoring resource utilization based on bandwidth (e.g., bps). The bandwidth quota column 215 may specify an bandwidth quota for the process/PASID in bps. In some embodiments, the bandwidth quota may include separate quotas for transmit bandwidth receive bandwidth.

As shown, table 206 is based on percent utilization of a PCIe endpoint (e.g., one of the peripheral devices 106), and includes a PASID column 217, a PCIe endpoint column 219, an RMID column 221, and a percent utilization quota column 223. The PASID column 217 may specify a PASID associated with a process. The PCIe endpoint column 219 may specify a PCIe endpoint, e.g., one of the peripheral devices 106. The RMID column 221 may specify a resource monitoring identifier (ID), which may be a per-thread tag for monitoring resource utilization based on percent utilization of a peripheral device 106. The percent utilization quota column 223 may specify a percent utilization quota for the process/PASID.

As shown in tables 202, 204, and 206, a given process may consume more than one peripheral device 106. Furthermore, such a process may individually consume a respective quota for each peripheral device 106. For example, as shown in table 202, the process with a PASID 201 of “PASID0” is allocated “M” ops for a peripheral device 106 (e.g., a NIC) having a PCIe endpoint identifier 203 of “0” and is allocated “J” ops for a peripheral device 106 (e.g., an accelerator) having a PCIe endpoint identifier 203 of “1”, where “M” and “J” are integers.

Therefore, the process associated with PASID0 may consume M ops of the NIC while also consuming J ops of the accelerator.

Furthermore, as shown, a given peripheral device 106 may be consumed by more than one process based on virtualization. For example, as shown in table 204, a peripheral device 106 having a PCIe endpoint identifier 211 of “0” is shared by two processes, namely processes having PASID 209 values of “PASID0” and “PASID1.” Furthermore, as shown, each process has a respective Mbps allocation defined in column 215, namely “M” Mbps for the process associated with PASID0 and “K” Mbps for the process associated with PASIDI, where “M” and “K” are integers. Therefore, the process associated with PASID0 may consume M Mbps of a peripheral device 106 while the process associated with PASIDI may consume K Mbps of the same peripheral device 106.

In some embodiments, at least a portion of the tables 202, 204, and 206 may be stored as the configuration 116 of the ENQCMD engine 112. In such embodiments, the values in the OPS quota column 207, bandwidth quota column 215, and percent utilization quota column 223 may correspond to the bandwidth, OPS, and percent utilization quotas for the corresponding process based on PASID. These bandwidth, OPS, and/or percent utilization quotas may be specific to an interval, e.g., a time interval. Therefore, at the beginning of a new interval, the quota values in the tables 202, 204, and 206 may be added to the current (or remaining) quotas for the process. In such embodiments, the ENQCMD engine 112 may include additional circuitry or features to maintain current (or remaining) bandwidth, OPS, and/or percent utilization quotas that are updated at each time interval based on the quota values in the tables 202, 204, and 206.

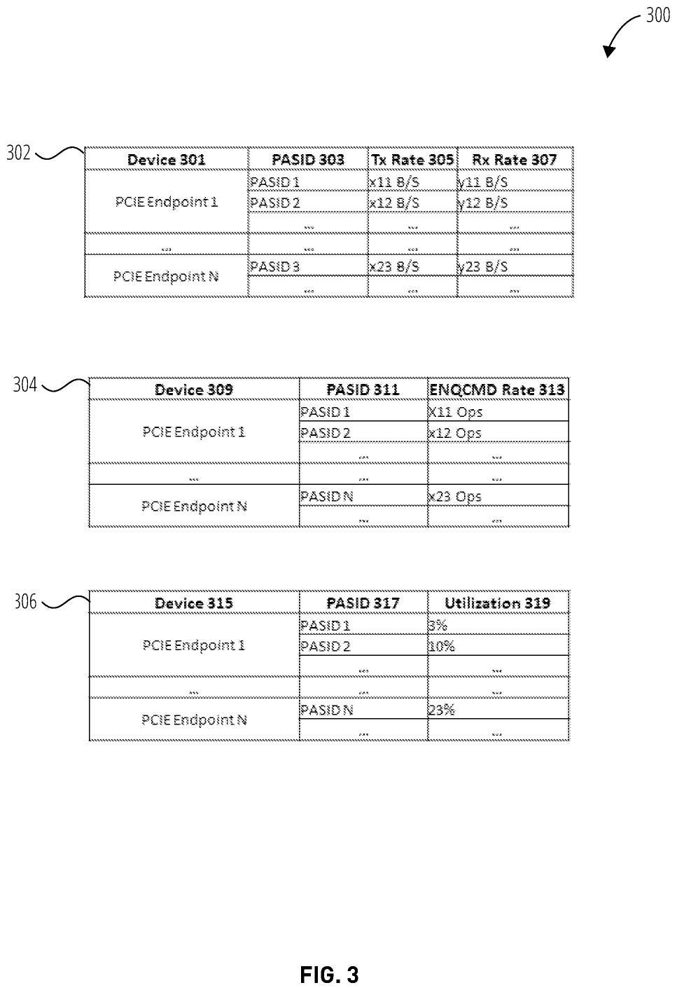

FIG. 3 is a schematic 300 reflecting different metrics 114 collected as ENQCMDs are submitted to the peripheral devices 106 and the corresponding operations and/or workloads are executed by the peripheral devices 106. As shown, table 302 is a bandwidth monitoring table, while table 304 is an OPS monitoring table, and table 306 is a percent utilization monitoring table. Therefore, the monitor 120 of the IIO controller 118 may generate table 302, the ENQCMD engine 112 may generate table 304, and the processor 102 may generate table 306.

Operations for the disclosed embodiments may be further described with reference to the following figures. Some of the figures may include a logic flow. Although such figures presented herein may include a particular logic flow, it can be appreciated that the logic flow merely provides an example of how the general functionality as described herein can be implemented. Further, a given logic flow does not necessarily have to be executed in the order presented unless otherwise indicated. Moreover, not all acts illustrated in a logic flow may be required in some embodiments. In addition, the given logic flow may be implemented by a hardware element, a software element executed by a processor, or any combination thereof. The embodiments are not limited in this context.

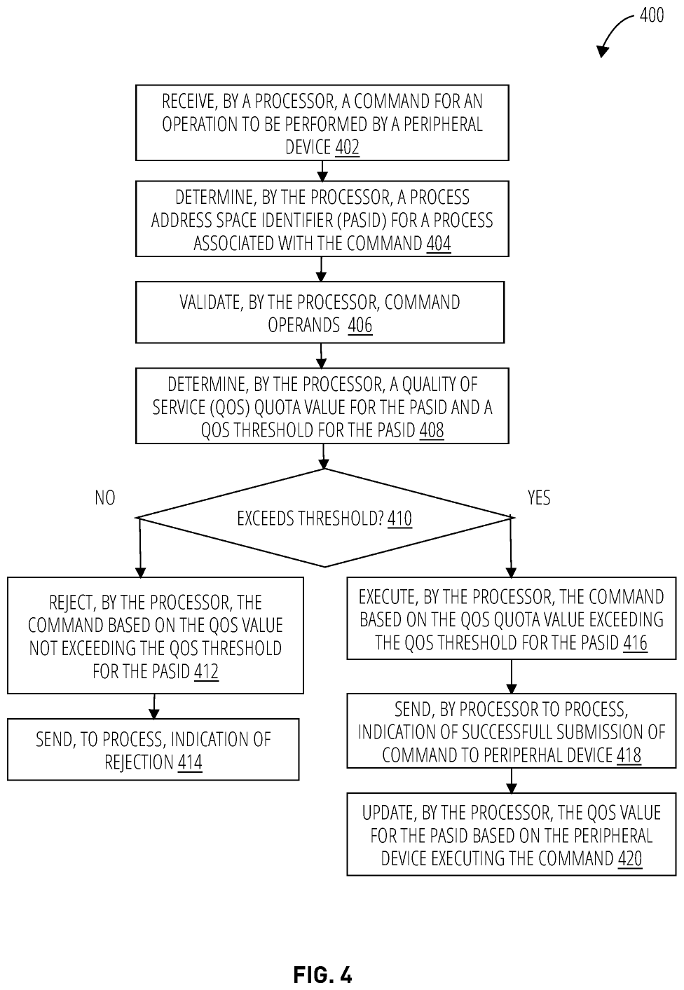

FIG. 4 illustrates an embodiment of a logic flow 400. The logic flow 400 may be representative of some or all of the operations executed by one or more embodiments described herein. For example, the logic flow 400 may include some or all of the operations performed by the ENQCMD engine 112 to process one or more ENQCMD commands issued by one or more processes. The embodiments are not limited in this context.

In block 402, the processor 102 may receive a command for an operation to be performed by a peripheral device 106. For example, the process 108a may generate the ENQCMD 122a, which may be received by the ENQCMD engine 112. In block 404, the processor 102 determines a PASID of a process associated with the command. For example, the ENQCMD engine 112 may retrieve the PASID from one or more registers of the processor 102, e.g., IA32_PASID MSR in the Intel ISA. At block 406, the ENQCMD engine 112 may validate the operands of the ENQCMD command. In block 408, the ENQCMD engine 112 may determine a Quality of Service (QoS) quota value for the PASID and a predetermined QoS threshold for the PASID. The QoS quota value may include one or more of a bandwidth quota, an OPS quota, and/or a percent utilization quota. The QoS threshold may be one or more of a minimum bandwidth threshold, a minimum OPS threshold, and/or a minimum percent utilization threshold.

At block 410, the ENQCMD engine 112 may determine whether the QoS quota value exceeds the QoS threshold. If the QoS quota value does not exceed the threshold, the process does not have remaining quota available, and the logic flow proceeds to block 412. In block 412, the ENQCMD engine 112 may not execute (e.g., reject) the command based on the QoS quota value not exceeding the QoS threshold for the PASID. At block 414, the ENQCMD engine 112 may return a response to the process indicating that the ENQCMD command was not executed. Doing so may cause the process to wait a predetermined amount of time and/or cycles before resubmitting the command.

Returning to block 410, if the QoS quota value exceeds the threshold, the process has quota available to execute ENQCMD commands, and the logic flow proceeds to block 416. In block 416, the ENQCMD engine 112 may accept the command based on the QOS quota value exceeding the QoS threshold for the PASID. Generally, to accept the command, the ENQCMD engine 112 may execute the command to transfer the encoded command descriptor to the peripheral device 106 using a non-posted write. At block 418, the ENQCMD engine 112 may return, to the process, an indication specifying that the ENQCMD was successfully submitted to the peripheral device 106. In block 420 the ENQCMD engine 112 may update the QoS value for the PASID based on the peripheral device executing one or more operations associated with the command. For example, the ENQCMD engine 112 may receive PCIe bandwidth used in executing the operations associated with the command from the IIO controller 118. The ENQCMD engine 112 may then update a bandwidth quota for the process. Similarly, the ENQCMD engine 112 may determine the OPS used in executing the operations associated with the command, and update the OPS quota for the process accordingly. Further still, the ENQCMD engine 112 may determine the percent of the resources of the peripheral device 106 used in executing the operations associated with the command, and update the percent utilization quota for the process. Doing so allows the ENQCMD engine 112 to ensure QoS for the process (and other processes) submitting subsequent ENQCMD commands.

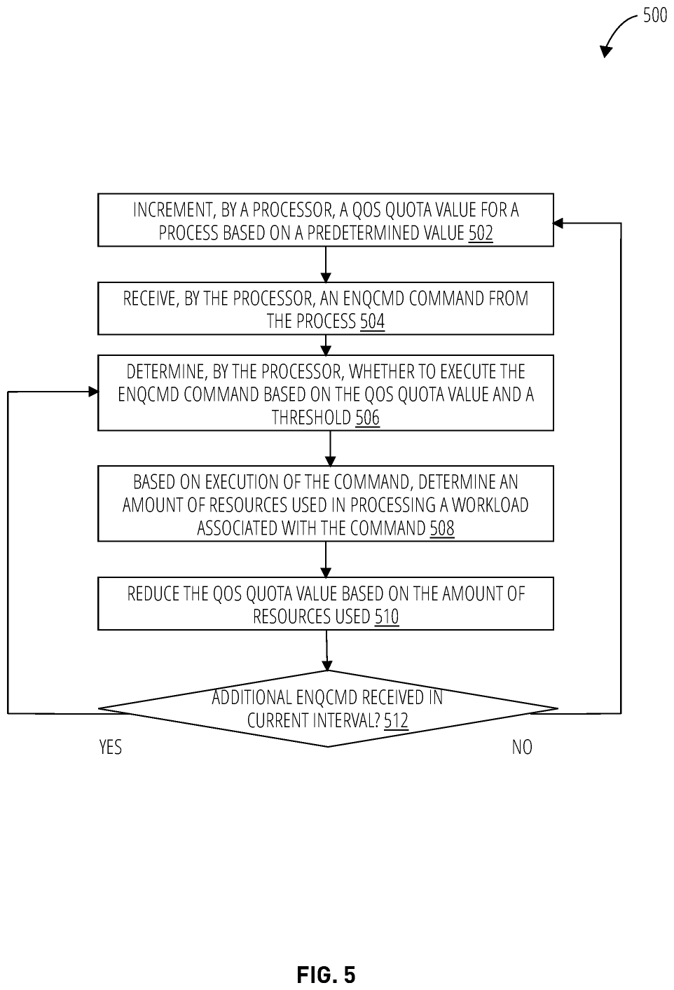

FIG. 5 illustrates an embodiment of a logic flow 500. The logic flow 500 may be representative of some or all of the operations executed by one or more embodiments described herein. For example, the logic flow 500 may include some or all of the operations performed by the ENQCMD engine 112 to maintain one or more QoS quotas for one or more processes. The embodiments are not limited in this context.

In block 502, the ENQCMD engine 112 may increment a QoS quota value for a process based on a predetermined value associated with the process. The value may be incremented based on the start of a new interval of a plurality of intervals, e.g., a new time interval of a plurality of time intervals. For example, the predetermined value may be 10 megabits per second, 1 million OPS, and/or 10% utilization of the peripheral device 106. In block 504 the ENQCMD engine 112 receives an ENQCMD command from the process. In block 506, the ENQCMD engine 112 determines whether to execute the ENQCMD command based on the QoS quota value and a threshold (e.g., a minimum bandwidth threshold, a minimum OPS threshold, and/or a minimum percent utilization threshold). In block 508, based on execution of the ENQCMD command, the ENQCMD engine 112 determines an amount of resources used in processing a workload associated with the command. In block 510, the ENQCMD engine 112 reduces the QoS quota value based on the amount of resources used. If, however, the ENQCMD is not executed at block 506, no resources are used, and the QoS quota value remains the same. In such embodiments, the QoS quota may be incremented at the start of the next interval, which may permit the process to execute the ENQCMD.

At block 512, the ENQCMD engine 112 determines whether another ENQCMD is received for the current time interval. If another ENQCMD is received, the logic flow returns to block 506 for QoS processing of the ENQCMD based on the current QoS quota value. If another ENQCMD is not received, the logic flow returns to block 502, e.g., the start of a new time interval.

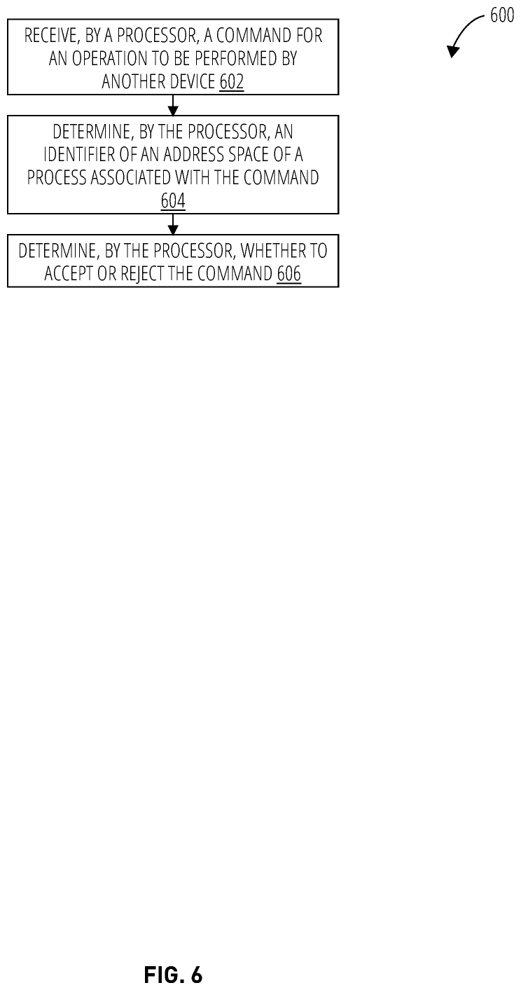

FIG. 6 illustrates an embodiment of a logic flow 600. The logic flow 600 may be representative of some or all of the operations executed by one or more embodiments described herein. For example, the logic flow 600 may include some or all of the operations performed by the ENQCMD engine 112 to process one or more ENQCMD commands issued by one or more processes. The embodiments are not limited in this context.

In block 602, a processor 102 may receive a command for an operation to be performed by another device, such as the peripheral device 106. In block 604, the processor 102 determines an identifier of an address space of a process associated with the command. In block 606, the processor 102 determines whether to accept or reject the command.

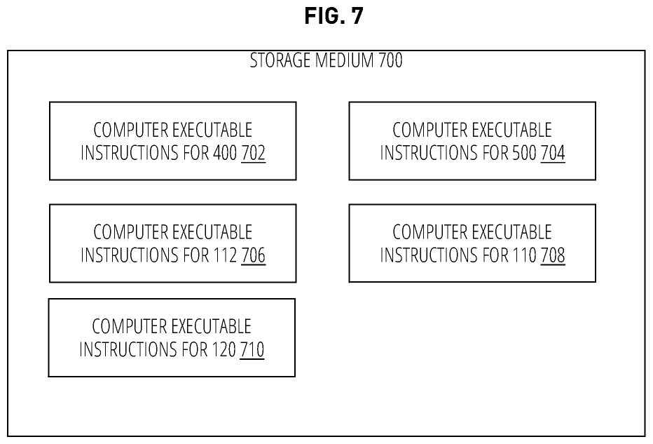

FIG. 7 illustrates an embodiment of a storage medium 700. Storage medium 700 may comprise any non-transitory computer-readable storage medium or machine-readable storage medium, such as an optical, magnetic, or semiconductor storage medium. In various embodiments, storage medium 700 may comprise an article of manufacture. In some embodiments, storage medium 700 may store computer-executable instructions, such as computer-executable instructions to implement one or more of logic flows or operations described herein, such as instructions 702, 704, for logic flows 400, 500 of FIGS. 4-5, respectively. The storage medium 700 may further store computer-executable instructions 706 for the ENQCMD engine 112, instructions 708 for the resource director 110, and/or instructions 710 for the monitor 120. The processor 102 may execute any of the instructions in storage medium 700. Examples of a computer-readable storage medium or machine-readable storage medium may include any tangible media capable of storing electronic data, including volatile memory or non-volatile memory, removable or non-removable memory, erasable or non-erasable memory, writeable or re-writeable memory, and so forth. Examples of computer-executable instructions may include any suitable type of code, such as source code, compiled code, interpreted code, executable code, static code, dynamic code, object-oriented code, visual code, and the like. The embodiments are not limited in this context.

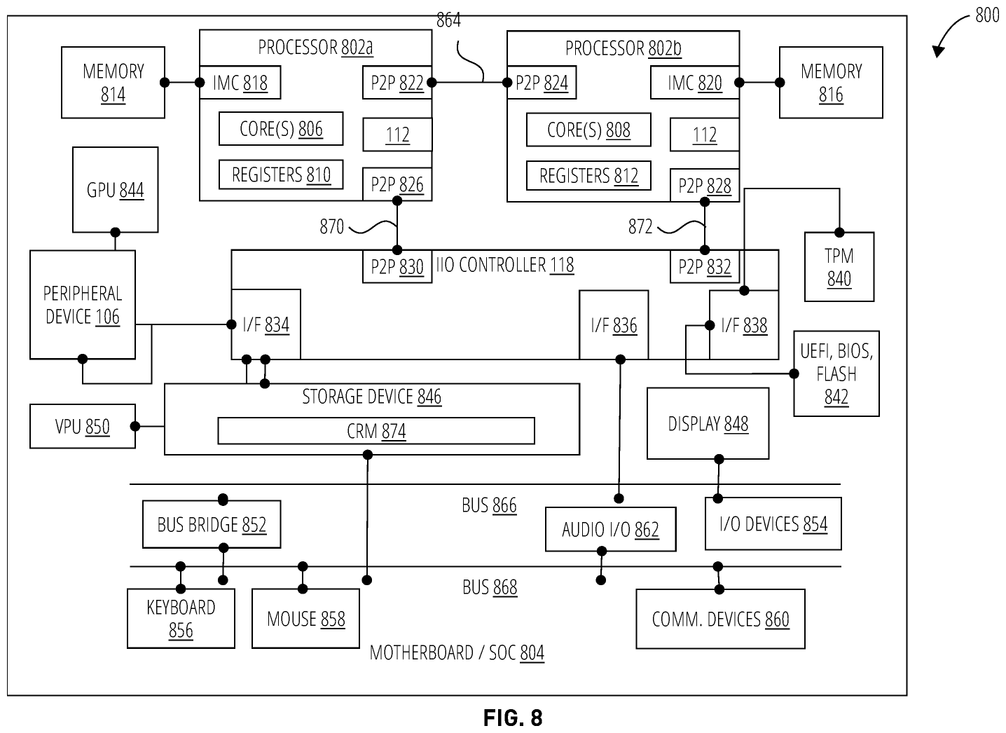

FIG. 8 illustrates an embodiment of a system 800. System 800 is a computer system with multiple processor cores such as a distributed computing system, supercomputer, high-performance computing system, computing cluster, mainframe computer, mini-computer, client-server system, personal computer (PC), workstation, server, portable computer, laptop computer, tablet computer, handheld device such as a personal digital assistant (PDA), or other device for processing, displaying, or transmitting information. Similar embodiments may comprise, e.g., entertainment devices such as a portable music player or a portable video player, a smart phone or other cellular phone, a telephone, a digital video camera, a digital still camera, an external storage device, or the like. Further embodiments implement larger scale server configurations. In other embodiments, the system 800 may have a single processor with one core or more than one processor. Note that the term “processor” refers to a processor with a single core or a processor package with multiple processor cores. In at least one embodiment, the computing system 800 is representative of the components of the system 100, including processor 102, memory 104, IIO controller 118, and peripheral device 106. More generally, the computing system 800 is configured to implement all logic, systems, logic flows, methods, apparatuses, and functionality described herein with reference to FIGS. 1A-7.

As used in this application, the terms “system” and “component” and “module” are intended to refer to a computer-related entity, either hardware, a combination of hardware and software, software, or software in execution, examples of which are provided by the exemplary system 800. For example, a component can be, but is not limited to being, a process running on a processor, a processor, a hard disk drive, multiple storage drives (of optical and/or magnetic storage medium), an object, an executable, a thread of execution, a program, and/or a computer. By way of illustration, both an application running on a server and the server can be a component. One or more components can reside within a process and/or thread of execution, and a component can be localized on one computer and/or distributed between two or more computers. Further, components may be communicatively coupled to each other by various types of communications media to coordinate operations. The coordination may involve the uni-directional or bi-directional exchange of information. For instance, the components may communicate information in the form of signals communicated over the communications media. The information can be implemented as signals allocated to various signal lines. In such allocations, each message is a signal. Further embodiments, however, may alternatively employ data messages. Such data messages may be sent across various connections. Exemplary connections include parallel interfaces, serial interfaces, and bus interfaces.

As shown in this figure, system 800 comprises a motherboard or system-on-chip(SoC) 804 for mounting platform components. Motherboard or system-on-chip(SoC) 804 is a point-to-point (P2P) interconnect platform that includes a first processor 802a and a second processor 802b coupled via a point-to-point interconnect 864 such as an Ultra Path Interconnect (UPI). In other embodiments, the system 800 may be of another bus architecture, such as a multi-drop bus. Furthermore, each of processor 802a and processor 802b may be processor packages with multiple processor cores including core(s) 806 and core(s) 808, respectively. While the system 800 is an example of a two-socket (2S) platform, other embodiments may include more than two sockets or one socket. For example, some embodiments may include a four-socket (4S) platform or an eight-socket (8S) platform. Each socket is a mount for a processor and may have a socket identifier. Note that the term platform refers to the motherboard with certain components mounted such as the processor 802a and IIO controller 118. Some platforms may include additional components and some platforms may only include sockets to mount the processors and/or the chipset. Furthermore, some platforms may not have sockets (e.g. SoC, or the like).

The processor 802a and the processor 802b may be representative of the processor 102 of FIG. 1. For example, as shown, the processor 802a and the processor 802b each include an instance of the ENQCMD engine 112. The processor 802a and processor 802b can be any of various commercially available processors, including without limitation an Intel@Celeron®, Core®, Core (2) Duo®, Itanium®, Pentium®, Xeon®, and XScale® processors; AMD@Athlon®, Duron® and Opteron® processors; ARM® application, embedded and secure processors; IBM® and Motorola® DragonBall® and PowerPC® processors; IBM and Sony® Cell processors; and similar processors. Dual microprocessors, multi-core processors, and other multi-processor architectures may also be employed as the processor 802a and/or processor 802b. Additionally, the processor 802a need not be identical to processor 802b.

Processor 802a includes an integrated memory controller (IMC) 818 and point-to-point (P2P) interface 822 and P2P interface 826. Similarly, the processor 802b includes an IMC 820 as well as P2P interface 824 and P2P interface 828. IMC 818 and IMC 820 couple the processors processor 802a and processor 802b, respectively, to respective memories (e.g., memory 814 and memory 816). Memory 814 and memory 816 may be portions of the main memory (e.g., a dynamic random-access memory (DRAM)) for the platform such as double data rate type 3 (DDR3) or type 4 (DDR4) synchronous DRAM (SDRAM). In the present embodiment, the memories memory 814 and memory 816 locally attach to the respective processors (i.e., processor 802a and processor 802b). In other embodiments, the main memory may couple with the processors via a bus and shared memory hub. Processor 802a includes registers 810 and processor 802b includes registers 812.

System 800 includes IIO controller 118 coupled to processor 802a and processor 802b. Furthermore, IIO controller 118 can be coupled to storage device 846 including a CRM 874, for example, via an interface (I/F) 834. The CRM 874 may correspond to the storage medium 700. The I/F 834 may be, for example, a PCIe interface, a CXL interface, and/or a UCIe interface. Storage device 846 can store instructions executable by circuitry of system 800 (e.g., processor 802a, processor 802b, GPU 844, peripheral device 106, vision processing unit 850, or the like). In some embodiments, storage device 846 and vision processing unit 850 are examples of peripheral devices 106.

Processor 802a couples to an IIO controller 118 via P2P interface 826 and P2P 830 while processor 802b couples to the IIO controller 118 via P2P interface 828 and P2P 832.

Direct media interface (DMI) 870 and DMI 872 may couple the P2P interface 826 and the P2P 830 and the P2P interface 828 and P2P 832, respectively. DMI 870 and DMI 872 may be a high-speed interconnect that facilitates, e.g., eight Giga Transfers per second (GT/s) such as DMI 3.0. In other embodiments, the processor 802a and processor 802b may interconnect via a bus.

The IIO controller 118 may comprise a controller hub such as a platform controller hub (PCH). The IIO controller 118 may include a system clock to perform clocking functions and include interfaces for an I/O bus such as a universal serial bus (USB), peripheral component interconnects (PCIs), PCI express (PCIe) interconnects, serial peripheral interconnects (SPIs), integrated interconnects (I2Cs), and the like, to facilitate connection of peripheral devices on the platform. In other embodiments, the IIO controller 118 may comprise more than one controller hub such as a chipset with a memory controller hub, a graphics controller hub, and an input/output (I/O) controller hub.

In the depicted example, IIO controller 118 couples with a trusted platform module (TPM) 840 and UEFI, BIOS, FLASH circuitry 842 via I/F 838. The I/F 838 may be, for example, a PCIe interface, a CXL interface, and/or a UCIe interface. The TPM 840 is a dedicated microcontroller designed to secure hardware by integrating cryptographic keys into devices. The UEFI, BIOS, FLASH circuitry 842 may provide pre-boot code.

Furthermore, IIO controller 118 includes the I/F 834 to couple IIO controller 118 with a high-performance graphics engine, such as, graphics processing circuitry or a graphics processing unit (GPU) 844. In other embodiments, the system 800 may include a flexible display interface (FDI) (not shown) between the processor 802a and/or the processor 802b and the IIO controller 118. The FDI interconnects a graphics processor core in one or more of processor 802a and/or processor 802b with the IIO controller 118.

Additionally, Peripheral device 106 and/or vision processing unit 850 can be coupled to IIO controller 118 via I/F 834. In some examples, peripheral device 106 can be circuitry arranged to execute ML related operations (e.g., training, inference, etc.) for ML models. Likewise, vision processing unit 850 can be circuitry arranged to execute vision processing specific or related operations. In particular, peripheral device 106 and/or vision processing unit 850 can be arranged to execute mathematical operations and/or operands useful for machine learning, neural network processing, artificial intelligence, vision processing, etc.

Various I/O devices 854 and display 848 couple to the bus 866, along with a bus bridge 852 which couples the bus 866 to a second bus 868 and an I/F 836 that connects the bus 866 with the IIO controller 118. In one embodiment, the second bus 868 may be a low pin count (LPC) bus. Various devices may couple to the second bus 868 including, for example, a keyboard 856, a mouse 858 and communication devices 860.

Furthermore, an audio I/O 862 may couple to second bus 868. Many of the I/O devices 854 and communication devices 860 may reside on the motherboard or system-on-chip(SoC) 804 while the keyboard 856 and the mouse 858 may be add-on peripherals. In other embodiments, some or all the I/O devices 854 and communication devices 860 are add-on peripherals and do not reside on the motherboard or system-on-chip(SoC) 804.

The various elements of the devices as previously described with reference to FIGS. 1-7 may include various hardware elements, software elements, or a combination of both. Examples of hardware elements may include devices, logic devices, components, processors, microprocessors, circuits, processors, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), memory units, logic gates, registers, semiconductor device, chips, microchips, chip sets, and so forth. Examples of software elements may include software components, programs, applications, computer programs, application programs, system programs, software development programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. However, determining whether an embodiment is implemented using hardware elements and/or software elements may vary in accordance with any number of factors, such as desired computational rate, power levels, heat tolerances, processing cycle budget, input data rates, output data rates, memory resources, data bus speeds and other design or performance constraints, as desired for a given implementation.

One or more aspects of at least one embodiment may be implemented by representative instructions stored on a machine-readable medium which represents various logic within the processor, which when read by a machine causes the machine to fabricate logic to perform the techniques described herein. Such representations, known as “IP cores” may be stored on a tangible, machine readable medium and supplied to various customers or manufacturing facilities to load into the fabrication machines that make the logic or processor. Some embodiments may be implemented, for example, using a machine-readable medium or article which may store an instruction or a set of instructions that, if executed by a machine, may cause the machine to perform a method and/or operations in accordance with the embodiments. Such a machine may include, for example, any suitable processing platform, computing platform, computing device, processing device, computing system, processing system, computer, processor, or the like, and may be implemented using any suitable combination of hardware and/or software. The machine-readable medium or article may include, for example, any suitable type of memory unit, memory device, memory article, memory medium, storage device, storage article, storage medium and/or storage unit, for example, memory, removable or non-removable media, erasable or non-erasable media, writeable or re-writeable media, digital or analog media, hard disk, floppy disk, Compact Disk Read Only Memory (CD-ROM), Compact Disk Recordable (CD-R), Compact Disk Rewriteable (CD-RW), optical disk, magnetic media, magneto-optical media, removable memory cards or disks, various types of Digital Versatile Disk (DVD), a tape, a cassette, or the like. The instructions may include any suitable type of code, such as source code, compiled code, interpreted code, executable code, static code, dynamic code, encrypted code, and the like, implemented using any suitable high-level, low-level, object-oriented, visual, compiled and/or interpreted programming language.

It will be appreciated that the exemplary devices shown in the block diagrams described above may represent one functionally descriptive example of many potential implementations. Accordingly, division, omission or inclusion of block functions depicted in the accompanying figures does not infer that the hardware components, circuits, software and/or elements for implementing these functions would necessarily be divided, omitted, or included in embodiments.

At least one computer-readable storage medium may include instructions that, when executed, cause a system to perform any of the computer-implemented methods described herein.

Some embodiments may be described using the expression “one embodiment” or “an embodiment” along with their derivatives. These terms mean that a particular feature, structure, or characteristic described in connection with the embodiment is included in at least one embodiment. The appearances of the phrase “in one embodiment” in various places in the specification are not necessarily all referring to the same embodiment. Moreover, unless otherwise noted the features described above are recognized to be usable together in any combination. Thus, any features discussed separately may be employed in combination with each other unless it is noted that the features are incompatible with each other.

The following examples pertain to further embodiments, from which numerous permutations and configurations will be apparent.

Example 1 includes an apparatus, comprising: an interface to memory; and a processor comprising circuitry configured to: receive a command for an operation to be performed by another device; determine an identifier of an address space of a process associated with the command; and determine whether to accept or reject the command.

Example 2 includes the subject matter of any preceding example, wherein the command is to atomically submit a work descriptor to the another device.

Example 3 includes the subject matter of any preceding example, wherein the command is to comprise indications of: the operation, a source address, a destination address for a device specific register of the another device, and the identifier of the address space of the process.

Example 4 includes the subject matter of any preceding example, wherein the determination whether to accept or reject the command is based on a Quality of Service (QoS) quota value for the identifier of the address space of the process and a QoS threshold.

Example 5 includes the subject matter of any preceding example, wherein the QoS threshold comprises one or more of a bandwidth quota threshold, an operations per second (OPS) quota threshold, or a utilization quota threshold, wherein the QoS quota value comprises one or more of a bandwidth quota allocated to the identifier of the address space of the process, an OPS quota allocated to the identifier of the address space of the process, or a percent utilization of the another device allocated to the identifier of the address space of the process.

Example 6 includes the subject matter of any preceding example, wherein the bandwidth used by the identifier of the address space of the process is to be received by the processor from an integrated input/output (IIO) controller coupling the processor and the another device, wherein the OPS performed by the identifier of the address space of the process is to be determined by the processor, wherein the utilization of the another device by the identifier of the address space of the process is to be determined by the processor.

Example 7 includes the subject matter of any preceding example, wherein the circuitry is configured to: determine that an amount of resources to be used by the another device in performing the operation, wherein the command is further rejected based on the amount of resources exceeding the QoS quota value.

Example 8 includes the subject matter of any preceding example, wherein the circuitry is configured to: return, to the process, an indication that the command was rejected; receive, from the process, a second instance of the command for the operation to be performed by the another device; and execute, based on the QoS quota value for the identifier of the address space of the process and the QoS threshold for the identifier of the address space of the process, the second instance of the command to submit the second instance of the command to a shared work queue of the another device based on a non-posted memory write.

Example 9 includes the subject matter of any preceding example, wherein the circuitry is configured to, prior to receiving the second instance of the command: increment the QoS quota value based on a predetermined value, wherein the processor executes the second instance of the command based on the incremented QoS quota value and the QoS threshold.

Example 10 includes the subject matter of any preceding example, wherein the circuitry is configured to: return, to the process, an indication that the second instance of the command was submitted to the shared work queue.

Example 11 includes the subject matter of any preceding example, wherein the circuitry is configured to: update, by the processor, the QoS quota value for the identifier of the address space of the process based on resources used by the another device in processing the operation associated with the second instance of the command.

Example 12 includes the subject matter of any preceding example, wherein the QoS quota value is based on a predetermined quota value associated with the identifier of the address space of the process.

Example 13 includes the subject matter of any preceding example, wherein the process is associated with one or more of: (i) an application, (ii) a container, (iii) a virtual machine, or (iv) a microservice.

Example 14 includes the subject matter of any preceding example, wherein the another device comprises a Peripheral Component Interconnect Express (PCIe) device, a Compute Express Link (CXL) device, or a Universal Chiplet Interconnect Express (UCIe) device.

Example 15 includes a method, comprising: receiving, by a processor, a command for an operation to be performed by another device; determining, by the processor, an identifier of an address space of a process associated with the command; and determining, by the processor, whether to accept or reject the command.

Example 16 includes the subject matter of any preceding example, wherein the command is to atomically submit a work descriptor to the another device.

Example 17 includes the subject matter of any preceding example, wherein the command comprises indications of: the operation, a source address, a destination address for a device specific register of the another device, and the identifier of the address space of the process.

Example 18 includes the subject matter of any preceding example, wherein the determination whether to accept or reject the command is based on a Quality of Service (QoS) quota value for the identifier of the address space of the process and a QoS threshold, wherein the QoS threshold comprises one or more of a bandwidth quota threshold, an operations per second (OPS) quota threshold, or a utilization quota threshold, wherein the QoS quota value comprises one or more of a bandwidth quota allocated to the identifier of the address space of the process, an OPS quota allocated to the identifier of the address space of the process, or a percent utilization of the another device allocated to the identifier of the address space of the process.

Example 19 includes the subject matter of any preceding example, wherein the bandwidth used by the identifier of the address space of the process is to be received by the processor from an integrated input/output (IIO) controller coupling the processor and the another device, wherein the OPS performed by the identifier of the address space of the process is to be determined by the processor, wherein the utilization of the another device by the identifier of the address space of the process is to be determined by the processor.

Example 20 includes the subject matter of any preceding example, further comprising: returning, by the processor to the process, an indication that the command was rejected; receiving, by the processor from the process, a second instance of the command for the operation to be performed by the another device; and executing, by the processor based on the QoS quota value for the identifier of the address space of the process and the QoS threshold for the identifier of the address space of the process, the second instance of the command to submit the second instance of the command to a shared work queue of the another device based on a non-posted memory write.

Example 21 includes the subject matter of any preceding example, wherein the QoS quota value is based on a predetermined quota value associated with the identifier of the address space of the process, wherein the QoS quota value, the predetermined quota value, and the QoS threshold are based on a service level agreement (SLA).

Example 22 includes the subject matter of any preceding example, further comprising, prior to receiving the second instance of the command: incrementing, by the processor, the QoS quota value based on a predetermined value, wherein the processor executes the second instance of the command based on the incremented QoS quota value and the QoS threshold.

23 includes the subject matter of any preceding example, further comprising: returning, by the processor to the process, an indication that the second instance of the command was submitted to the shared work queue.

Example 24 includes the subject matter of any preceding example, further comprising: updating, by the processor, the QoS quota value for the identifier of the address space of the process based on resources used by the another device in processing the operation associated with the second instance of the command.

Example 25 includes the subject matter of any preceding example, wherein the QoS quota value is based on a predetermined quota value associated with the identifier of the address space of the process.

Example 26 includes the subject matter of any preceding example, wherein the process is associated with one or more of: (i) an application, (ii) a container, (iii) a virtual machine, or (iv) a microservice.

Example 27 includes the subject matter of example 1, wherein the another device comprises a Peripheral Component Interconnect Express (PCIe) device, a Compute Express Link (CXL) device, or a Universal Chiplet Interconnect Express (UCIe) device.

Example 28 includes a processor circuit, comprising: an interface to memory; and circuitry configured to: receive a command for an operation to be performed by another device; determine an identifier of an address space of a process associated with the command; and determine whether to accept or reject the command.

Example 29 includes the subject matter of any preceding example, wherein the command is to atomically submit a work descriptor to the another device.

Example 30 includes the subject matter of any preceding example, wherein the command comprises indications of: the operation, a source address, a destination address for a device specific register of the another device, and the identifier of the address space of the process.

Example 31 includes the subject matter of any preceding example, wherein the determination whether to accept or reject the command is based on a Quality of Service (QoS) quota value for the identifier of the address space of the process and a QoS threshold.

Example 32 includes the subject matter of any preceding example, wherein the QoS threshold comprises one or more of a bandwidth quota threshold, an operations per second (OPS) quota threshold, or a utilization quota threshold, wherein the QoS quota value comprises one or more of a bandwidth quota allocated to the identifier of the address space of the process, an OPS quota allocated to the identifier of the address space of the process, or a percent utilization of the another device allocated to the identifier of the address space of the process.

Example 33 includes the subject matter of any preceding example, wherein the bandwidth used by the identifier of the address space of the process is to be received by the processor from an integrated input/output (IIO) controller coupling the processor and the another device, wherein the OPS performed by the identifier of the address space of the process is to be determined by the processor, wherein the utilization of the another device by the identifier of the address space of the process is to be determined by the processor.

Example 34 includes the subject matter of any preceding example, wherein the circuitry is configured to: determine that an amount of resources to be used by the another device in performing the operation, wherein the command is further rejected based on the amount of resources exceeding the QoS quota value.

Example 35 includes the subject matter of any preceding example, wherein the circuitry is configured to: return, to the process, an indication that the command was rejected; receive, from the process, a second instance of the command for the operation to be performed by the another device; and execute, based on the QoS quota value for the identifier of the address space of the process and the QoS threshold for the identifier of the address space of the process, the second instance of the command to submit the second instance of the command to a shared work queue of the another device based on a non-posted memory write.

Example 36 includes the subject matter of any preceding example, wherein the circuitry is configured to, prior to receiving the second instance of the command: increment the QoS quota value based on a predetermined value, wherein the processor executes the second instance of the command based on the incremented QoS quota value and the QoS threshold.

37 includes the subject matter of any preceding example, wherein the circuitry is configured to: return, to the process, an indication that the second instance of the command was submitted to the shared work queue.

Example 38 includes the subject matter of any preceding example, wherein the circuitry is configured to: update, by the processor, the QoS quota value for the identifier of the address space of the process based on resources used by the another device in processing the operation associated with the second instance of the command.

Example 39 includes the subject matter of any preceding example, wherein the QoS quota value is based on a predetermined quota value associated with the identifier of the address space of the process.

Example 40 includes the subject matter of any preceding example, wherein the process is associated with one or more of: (i) an application, (ii) a container, (iii) a virtual machine, or (iv) a microservice.

Example 41 includes the subject matter of any preceding example, wherein the another device comprises a Peripheral Component Interconnect Express (PCIe) device, a Compute Express Link (CXL) device, or a Universal Chiplet Interconnect Express (UCIe) device.

Example 42 includes a non-transitory computer-readable storage medium, the computer-readable storage medium including instructions that when executed by a computer, cause the computer to: receive, by a processor, a command for an operation to be performed by another device; determine, by the processor, an identifier of an address space of a process associated with the command; and determine, by the processor, whether to accept or reject the command.

Example 43 includes the subject matter of any preceding example, wherein the command is to atomically submit a work descriptor to the another device.

Example 44 includes the subject matter of any preceding example, wherein the command comprises indications of: the operation, a source address, a destination address for a device specific register of the another device, and the identifier of the address space of the process.

Example 45 includes the subject matter of any preceding example, wherein the determination whether to accept or reject the command is based on a Quality of Service (QoS) quota value for the identifier of the address space of the process and a QoS threshold, wherein the QoS threshold comprises one or more of a bandwidth quota threshold, an operations per second (OPS) quota threshold, or a utilization quota threshold, wherein the QoS quota value comprises one or more of a bandwidth quota allocated to the identifier of the address space of the process, an OPS quota allocated to the identifier of the address space of the process, or a percent utilization of the another device allocated to the identifier of the address space of the process.

Example 46 includes the subject matter of any preceding example, wherein the bandwidth used by the identifier of the address space of the process is to be received by the processor from an integrated input/output (IIO) controller couple the processor and the another device, wherein the OPS performed by the identifier of the address space of the process is to be determined by the processor, wherein the utilization of the another device by the identifier of the address space of the process is to be determined by the processor.

Example 47 includes the subject matter of any preceding example, wherein the instructions further configure the computer to: return, by the processor to the process, an indication that the command was rejected; receive, by the processor from the process, a second instance of the command for the operation to be performed by the another device; and execute, by the processor based on the QoS quota value for the identifier of the address space of the process and the QoS threshold for the identifier of the address space of the process, the second instance of the command to submit the second instance of the command to a shared work queue of the another device based on a non-posted memory write.

Example 48 includes the subject matter of any preceding example, wherein the QoS quota value is based on a predetermined quota value associated with the identifier of the address space of the process, wherein the QoS quota value, the predetermined quota value, and the QoS threshold are based on a service level agreement (SLA).

Example 49 includes the subject matter of any preceding example, wherein the instructions further configure the computer to, prior to receiving the second instance of the command: incrementing, by the processor, the QoS quota value based on a predetermined value, wherein the processor executes the second instance of the command based on the incremented QoS quota value and the QoS threshold.

50 includes the subject matter of any preceding example, wherein the instructions further configure the computer to: return, by the processor to the process, an indication that the second instance of the command was submitted to the shared work queue.

Example 51 includes the subject matter of any preceding example, wherein the instructions further configure the computer to: update, by the processor, the QoS quota value for the identifier of the address space of the process based on resources used by the another device in processing the operation associated with the second instance of the command.

Example 52 includes the subject matter of any preceding example, wherein the QoS quota value is based on a predetermined quota value associated with the identifier of the address space of the process.

Example 53 includes the subject matter of any preceding example, wherein the process is associated with one or more of: (i) an application, (ii) a container, (iii) a virtual machine, or (iv) a microservice.

Example 54 includes the subject matter of any preceding example, wherein the another device comprises a Peripheral Component Interconnect Express (PCIe) device, a Compute Express Link (CXL) device, or a Universal Chiplet Interconnect Express (UCIe) device.

Example 55 includes a method, comprising: means for receiving a command for an operation to be performed by another device; means for determining an identifier of an address space of a process associated with the command; and means for determining whether to accept or reject the command.

Example 56 includes the subject matter of any preceding example, wherein the command is to atomically submit a work descriptor to the another device.

Example 57 includes the subject matter of any preceding example, wherein the command comprises indications of: the operation, a source address, a destination address for a device specific register of the another device, and the identifier of the address space of the process.

Example 58 includes the subject matter of any preceding example, wherein the determination whether to accept or reject the command is based on a Quality of Service (QoS) quota value for the identifier of the address space of the process and a QoS threshold, wherein the QoS threshold comprises one or more of a bandwidth quota threshold, an operations per second (OPS) quota threshold, or a utilization quota threshold, wherein the QoS quota value comprises one or more of a bandwidth quota allocated to the identifier of the address space of the process, an OPS quota allocated to the identifier of the address space of the process, or a percent utilization of the another device allocated to the identifier of the address space of the process.

Example 59 includes the subject matter of any preceding example, wherein the bandwidth used by the identifier of the address space of the process is to be received by the processor from an integrated input/output (IIO) controller coupling the processor and the another device, wherein the OPS performed by the identifier of the address space of the process is to be determined by the processor, wherein the utilization of the another device by the identifier of the address space of the process is to be determined by the processor.

Example 60 includes the subject matter of any preceding example, further comprising: means for returning, to the process, an indication that the command was rejected; means for receiving, from the process, a second instance of the command for the operation to be performed by the another device; and means for executing, based on the QoS quota value for the identifier of the address space of the process and the QoS threshold for the identifier of the address space of the process, the second instance of the command to submit the second instance of the command to a shared work queue of the another device based on a non-posted memory write.

Example 61 includes the subject matter of any preceding example, wherein the QoS quota value is based on a predetermined quota value associated with the identifier of the address space of the process, wherein the QoS quota value, the predetermined quota value, and the QoS threshold are based on a service level agreement (SLA).

Example 62 includes the subject matter of any preceding example, further comprising, prior to receiving the second instance of the command: means for incrementing the QoS quota value based on a predetermined value, wherein the processor executes the second instance of the command based on the incremented QoS quota value and the QoS threshold.

Example 63 includes the subject matter of any preceding example, further comprising: means for returning, to the process, an indication that the second instance of the command was submitted to the shared work queue.

Example 64 includes the subject matter of any preceding example, further comprising: means for updating the QoS quota value for the identifier of the address space of the process based on resources used by the another device in processing the operation associated with the second instance of the command.

Example 65 includes the subject matter of any preceding example, wherein the QoS quota value is based on a predetermined quota value associated with the identifier of the address space of the process.

Example 66 includes the subject matter of any preceding example, wherein the process is associated with one or more of: (i) an application, (ii) a container, (iii) a virtual machine, or (iv) a microservice.

It is emphasized that the Abstract of the Disclosure is provided to allow a reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate embodiment. In the appended claims, the terms “including” and “in which” are used as the plain-English equivalents of the respective terms “comprising” and “wherein,” respectively. Moreover, the terms “first,” “second,” “third,” and so forth, are used merely as labels, and are not intended to impose numerical requirements on their objects.

The foregoing description of example embodiments has been presented for the purposes of illustration and description. It is not intended to be exhaustive or to limit the present disclosure to the precise forms disclosed. Many modifications and variations are possible in light of this disclosure. It is intended that the scope of the present disclosure be limited not by this detailed description, but rather by the claims appended hereto. Future filed applications claiming priority to this application may claim the disclosed subject matter in a different manner, and may generally include any set of one or more limitations as variously disclosed or otherwise demonstrated herein.

What is claimed is:

1. An apparatus, comprising:
an interface to memory; and
a processor comprising circuitry configured to:
receive a command for an operation to be performed by another device;
determine an identifier of an address space of a process associated with the command; and
determine whether to accept or reject the command.

2. The apparatus of claim 1, wherein the command is to atomically submit a work descriptor to the another device.

3. The apparatus of claim 1, wherein the command is to comprise indications of: the operation, a source address, a destination address for a device specific register of the another device, and the identifier of the address space of the process.

4. The apparatus of claim 1, wherein the determination whether to accept or reject the command is based on a Quality of Service (QoS) quota value for the identifier of the address space of the process and a QoS threshold.

5. The apparatus of claim 4, wherein the QoS threshold comprises one or more of a bandwidth quota threshold, an operations per second (OPS) quota threshold, or a utilization quota threshold, wherein the QoS quota value comprises one or more of a bandwidth quota allocated to the identifier of the address space of the process, an OPS quota allocated to the identifier of the address space of the process, or a percent utilization of the another device allocated to the identifier of the address space of the process.

6. The apparatus of claim 5, wherein the bandwidth used by the identifier of the address space of the process is to be received by the processor from an integrated input/output (IIO) controller coupling the processor and the another device, wherein the OPS performed by the identifier of the address space of the process is to be determined by the processor, wherein the utilization of the another device by the identifier of the address space of the process is to be determined by the processor.

7. The apparatus of claim 4, wherein the circuitry is configured to:
determine that an amount of resources to be used by the another device in performing the operation, wherein the command is further rejected based on the amount of resources exceeding the QoS quota value.

8. The apparatus of claim 4, wherein the circuitry is configured to:
return, to the process, an indication that the command was rejected;
receive, from the process, a second instance of the command for the operation to be performed by the another device; and
execute, based on the QoS quota value for the identifier of the address space of the process and the QoS threshold for the identifier of the address space of the process, the second instance of the command to submit the second instance of the command to a shared work queue of the another device based on a non-posted memory write.

9. The apparatus of claim 8, wherein the circuitry is configured to, prior to receiving the second instance of the command:
increment the QoS quota value based on a predetermined value, wherein the processor executes the second instance of the command based on the incremented QoS quota value and the QoS threshold.

10. The apparatus of claim 8, wherein the circuitry is configured to:
return, to the process, an indication that the second instance of the command was submitted to the shared work queue.

11. The apparatus of claim 8, wherein the circuitry is configured to:
update, by the processor, the QoS quota value for the identifier of the address space of the process based on resources used by the another device in processing the operation associated with the second instance of the command.

12. The apparatus of claim 4, wherein the QoS quota value is based on a predetermined quota value associated with the identifier of the address space of the process.

13. The apparatus of claim 1, wherein the process is associated with one or more of: (i) an application, (ii) a container, (iii) a virtual machine, or (iv) a microservice.

14. The apparatus of claim 1, wherein the another device comprises a Peripheral Component Interconnect Express (PCIe) device, a Compute Express Link (CXL) device, or a Universal Chiplet Interconnect Express (UCIe) device.

15. A method, comprising:
receiving, by a processor, a command for an operation to be performed by another device;
determining, by the processor, an identifier of an address space of a process associated with the command; and
determining, by the processor, whether to accept or reject the command.

16. The method of claim 15, wherein the command is to atomically submit a work descriptor to the another device.

17. The method of claim 15, wherein the command comprises indications of: the operation, a source address, a destination address for a device specific register of the another device, and the identifier of the address space of the process.

18. The method of claim 15, wherein the determination whether to accept or reject the command is based on a Quality of Service (QoS) quota value for the identifier of the address space of the process and a QoS threshold, wherein the QoS threshold comprises one or more of a bandwidth quota threshold, an operations per second (OPS) quota threshold, or a utilization quota threshold, wherein the QoS quota value comprises one or more of a bandwidth quota allocated to the identifier of the address space of the process, an OPS quota allocated to the identifier of the address space of the process, or a percent utilization of the another device allocated to the identifier of the address space of the process.

19. The method of claim 18, wherein the bandwidth used by the identifier of the address space of the process is to be received by the processor from an integrated input/output (IIO) controller coupling the processor and the another device, wherein the OPS performed by the identifier of the address space of the process is to be determined by the processor, wherein the utilization of the another device by the identifier of the address space of the process is to be determined by the processor.

20. The method of claim 18, further comprising:
returning, by the processor to the process, an indication that the command was rejected;
receiving, by the processor from the process, a second instance of the command for the operation to be performed by the another device; and
executing, by the processor based on the QoS quota value for the identifier of the address space of the process and the QoS threshold for the identifier of the address space of the process, the second instance of the command to submit the second instance of the command to a shared work queue of the another device based on a non-posted memory write.

21. The method of claim 18, wherein the QoS quota value is based on a predetermined quota value associated with the identifier of the address space of the process, wherein the QoS quota value, the predetermined quota value, and the QoS threshold are based on a service level agreement (SLA).

22. A processor circuit, comprising:
an interface to memory; and
circuitry configured to:
receive a command for an operation to be performed by another device;
determine an identifier of an address space of a process associated with the command; and
determine whether to accept or reject the command.

23. The processor circuit of claim 22, wherein the command is to atomically submit a work descriptor to the another device.

24. The processor circuit of claim 22, wherein the command comprises indications of: the operation, a source address, a destination address for a device specific register of the another device, and the identifier of the address space of the process.

25. The processor circuit of claim 22, wherein the determination whether to accept or reject the command is based on a Quality of Service (QoS) quota value for the identifier of the address space of the process and a QoS threshold.
